(19) United States
(12) Patent Application Publication
(10) Pub. No.: US 2004/0233165 A1
(43) Pub. Date: Nov. 25, 2004

(54) Recordable wireless cursor-controlling device

(76) Inventors: Chung-Ping Chi, Chung Ho City (TW); Kun-Chan Wu, Chung Ho City (TW)

Correspondence Address: YI WEN TSENG, 509 ROOSEVELT BLVD. #D306, FALLS CHURCH, VA, 22044, US

(21) Appl. No.: 10/441,042

(22) Filed: May 20, 2003

(51) Int. Cl. G09G 5/08

(52) U.S. Cl. 345/158

(57) ABSTRACT

A recordable wireless cursor-controlling device including a transmitter and a recorder is disclosed. The recorder has a microphone and a speaker. Therefore, the wireless cursor-controlling device can be used for controlling the computer cursor as well as a digital recording device. Furthermore, when more recording time is needed, it can use the transmitter to transmit the recording voice signal to the computer and store in a hard drive of the computer. Therefore, the recording ability can be further extended.

### BACKGROUND OF THE INVENTION

The present invention relates in general to a recordable wireless cursor-controlling device which combines an inputting device of the computer peripherals with the digital recording function.

A computer is more and more popularly used for a briefing in the meeting. It can provide an active performance without the projecting sheets. However, whether the briefing can be smoothly proceeded depends on if the computer can be easily used. While the speaker operates the software of the computer by himself or herself, it may limit his or her performance. Alternatively, it may need someone else to accompany the speaker. Both of these are not good enough. Therefore, a conventional wireless computer cursor-controlling device is provided for the speaker to hold on hand, such that the computer is controlled via infrared (IR) or radio frequency (RF) transmission. However, the traditional device provided mono cursor-controlling without any extra function is not enough. Thus, there still needs further improvement.

Furthermore, it is well know the digital recorders are compact without tapes. However, the recording time is limited by the memory size of the digital recorder. It has to empty the memory for further recording.

### BRIEF SUMMARY OF THE INVENTION

The present invention provides a recordable wireless cursor-controlling device which is not only for controlling the computer cursor but also as a digital recorder.

According to the present invention, a recordable wireless cursor-controlling device, comprising a housing; a control unit including a microprocessor, installed in the housing for receiving an input and outputting a respective signal; a cursor-moving controller installed in the housing and electrically connected to the control unit, for detecting a two-dimensional movement of a user's operation to generate a locating signal to be inputted to the control unit; a transmitter installed in the housing and electrically connected to the control unit, for demodulating the outputting signal from the control unit and transmitting a demodulated signal to a computer to control the movement of a computer cursor; a set of buttons including a recording button and a playback button, installed on the housing and electrically connected to the control unit; and a recorder installed in the housing, including a digital recording processor, a microphone and a speaker, when the recording button is pressed, voice is recorded via the microphone, and when the playback button is pressed, the recorded voice is played out via the speaker. Wherein the processor converts analog voice signals received from the microphone to digital voice signals, and stores the recorded voice in a built-in memory of the processor or the control unit.

When more recording time is needed, it can use a transmitter of the cursor-controlling device to transmit the recording voice signal to a computer and store in a hard drive of the computer. That is, the processor converts analog voice signals received from the microphone to digital voice signals, and sends the digital voice signals to the control unit so as to be transmitted by the transmitter to store the recorded voice in a hard drive of the computer. Therefore, the recording ability can be further extended.

### BRIEF DESCRIPTION OF THE DRAWINGS

These as well as other features of the present invention will become more apparent upon reference to the drawings wherein:

FIG. 1 shows the application of a recordable wireless cursor-controlling device according to the present invention; and

FIG. 2 shows a circuit diagram of present invention.

### DETAILED DESCRIPTION OF THE INVENTION

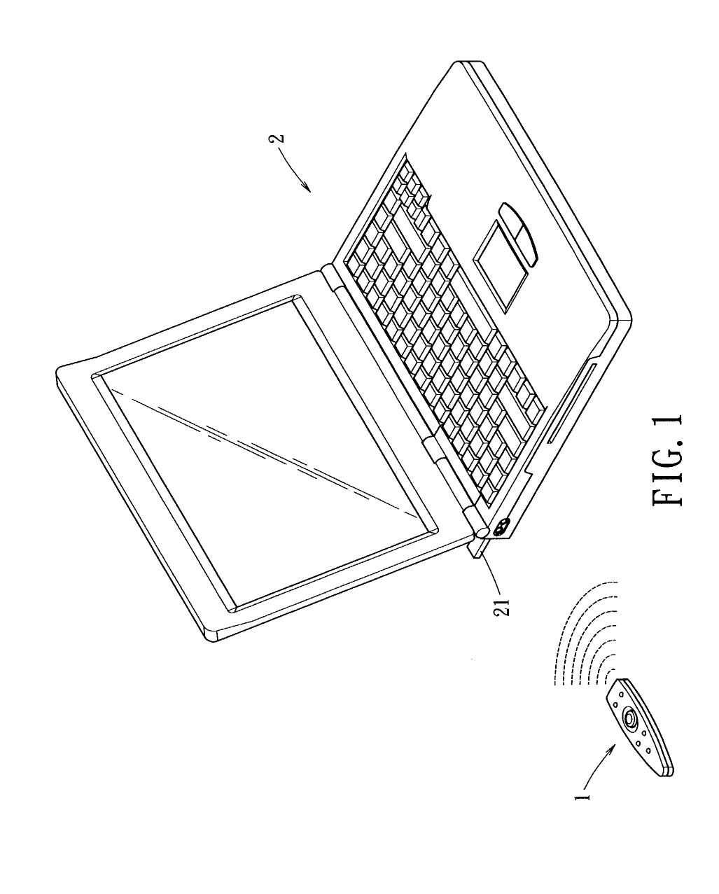

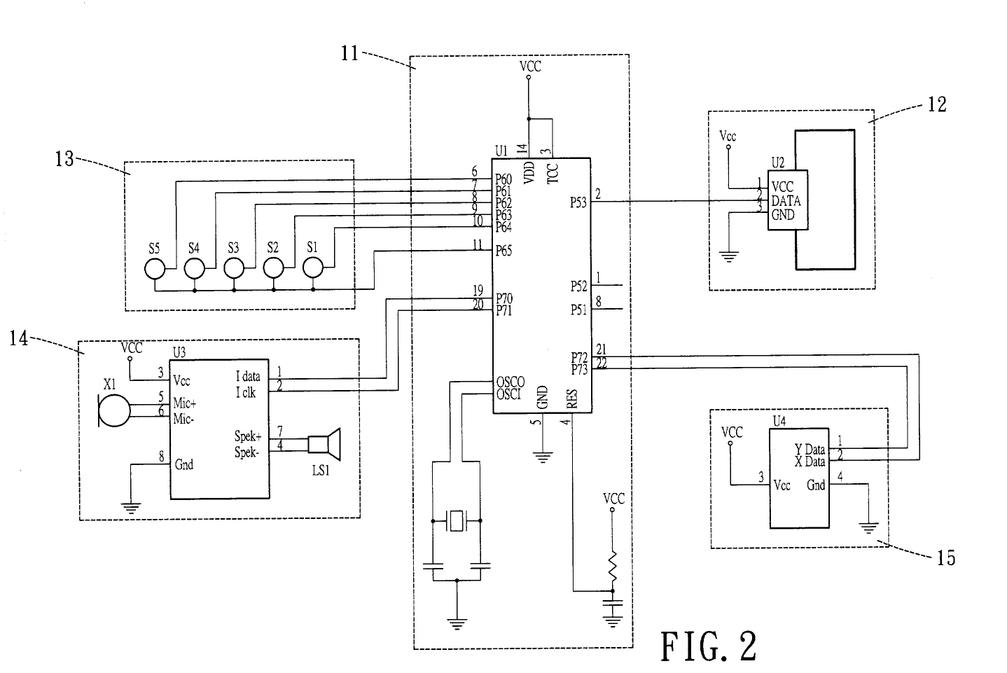

Please refer to FIG. 1, the recordable wireless computer cursor-controlling device 1 of the present invention is a hand-held device with the operation similar as a remote controller and a wireless mouse. It includes a housing and a circuit board. Further, a plurality of function buttons are installed on the housing for remotely controlling a computer 2, such as a laptop computer shown in FIG. 1 or other desktop personal computer, panel computer, hand-held computer and etc. As shown in FIG. 2, a circuit diagram of the present invention includes a control unit 11, a transmitter 12, a set of buttons 13, a recorder 14 and a two-dimensional moving controller 15. The control unit 11 including a microprocessor U1 is connected with the transmitter 12, the buttons 13, the recorder 14 and the cursor-moving controller 15. The buttons 13 includes one or more switches, such as five switches S1-S5 in this preferred embodiment to provide specific functional control such as page up/down and etc. The control unit 11 can receive an input as the buttons 13 are pressed and output a respective signal to the transmitter 12. The transmitter 12 then transmits the modulated signal as IR or RF signal to the computer. The cursor-moving controller 15 provides the user to control the movement of the computer cursor. The conventional cursor-moving controller 15 includes a ball button or a gyrostatic ball. When the ball is moving, the cursor-moving controller 15 can generate a locating signal by calculating the direction of the movement. The locating signal is then sent to the control unit 11 to be transferred as a serial signal for outputting to the transmitter 12. The signal is modulated and transmitted as IR or RF signal to be received by a receiver 21 of the computer. After the demodulation by the computer, the computer cursor is accordingly moved under the control of the present device. The recorder 14 includes a digital recording processor U3, a microphone X1 and speaker LS1. When a recording button of the buttons 13 is pressed, it is activated to record via the microphone X1. The processor U3 converts the analog voice signal received from the microphone X1 to the digital voice signal, and store to a built-in memory of the processor U3 or the control unit 11. When more recording time is needed, it can press a send button of the buttons 13 and the processor U3 will then send the digital voice signal to the control unit 11 to be transferred as a serial signal for outputting to the transmitter 12. Similarly, the signal is modulated and transmitted as IR or RF signal to be received by the computer and store in a hard drive of the computer. It may be further controlled by the present device 1 to make the computer to play the recorded voice. However, if the voice is recorded and stored in present device 1, it can be played by the speaker LS1. That is, the recordable wireless computer cursor-controlling device 1 of the present invention can be as a digital recording device. Furthermore, the recording voice signal can be transmitted to and store in the computer to extend the recording ability. Thus, it provides a wireless cursor-controlling device with an extendable digital recording function.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed:

1. A recordable wireless cursor-controlling device, comprising:
a housing;
a control unit including a microprocessor, installed in the housing for receiving an input and outputting a respective signal;
a moving controller installed in the housing and electrically connected to the control unit, for detecting a two-dimensional movement of a user's operation to generate a locating signal to be inputted to the control unit;
a transmitter installed in the housing and electrically connected to the control unit, for demodulating the outputting signal from the control unit and transmitting a demodulated signal to a computer to control the movement of a computer cursor;
a set of buttons including a recording button and a playback button, installed on the housing and electrically connected to the control unit; and
a recorder installed in the housing, including a digital recording processor, a microphone and a speaker, when the recording button is pressed, voice is recorded via the microphone, and when the playback button is pressed, the recorded voice is played out via the speaker.

2. The recordable wireless cursor-controlling device of claim 1, wherein the processor converts analog voice signals received from the microphone to digital voice signals, and stores the recorded voice in a built-in memory thereof.

3. The recordable wireless cursor-controlling device of claim 1, wherein the processor converts analog voice signals received from the microphone to digital voice signals, and stores the recorded voice in a built-in memory of the control unit.

4. The recordable wireless cursor-controlling device of claim 1, wherein the processor converts analog voice signals received from the microphone to digital voice signals, and sends the digital voice signals to the control unit so as to be transmitted by the transmitter to store the recorded voice in a hard drive of the computer.
